(19) United States
(12) Patent Application Publication
(10) Pub. No.: US 2023/0267129 A1
(43) Pub. Date: Aug. 24, 2023

(54) ERP SYSTEM PLATFORM FOR ACADEMIC INSTITUTIONS

(71) Applicant: Sustainable Outreach And Universal Leadership (SOUL) Limited, Bhubaneshwar (IN)

(72) Inventors: Sasmita Samanta, Bhubaneshwar (IN); Pabitra Behera, Bhubaneshwar (IN)

(21) Appl. No.: 18/310,130

(22) Filed: May 1, 2023

(51) Int. Cl. G06F 16/25

(52) U.S. Cl. CPC G06F 16/252

(57) ABSTRACT

The present invention relates to an ERP system (100) platform for academic institutions. The system (100) comprises of an enterprise resource planning database, an implementation module, an updating unit, and an application server. The enterprise resource planning database is used to process and store the data in real time. The implementation module is used to process, configure and deploy the enterprise resource planning in institutions. The updating unit is used to update the information of all components on enterprise resource planning database. The application server is connected with internet, to handle all the information between enterprise resource planning database and multiple users. The ERP system platform for academic institutions has been explored to deal with the issues related to a particular institution.

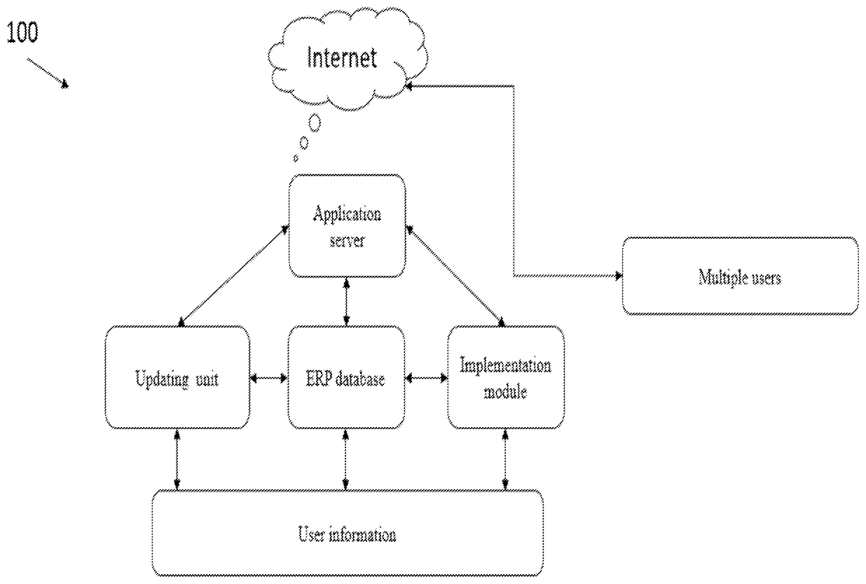

### FIELD

The present invention relates to a field of business management system and particularly a system for academic institutions using enterprise resource planning.

### BACKGROUND

Enterprise Resource Planning, sometimes known as ERP, is a business management tool or application used to handle departmental data related to qualified enterprises. Using common data held in site management systems, it gives an integrated perspective of business activities, typically in real-time. Conventional systems are complicated and time-consuming, required specialists to maintain and update the system and generating reports manually. This can lead to errors and time-consuming. The ERP platform is a web-based application that replaces the college-based system with a web-based automation system using an intuitive and appealing college interface. The ERP platform offers a single point of access to all college administration systems, doing away with the requirement for data, the challenges of updating data, non-fixed data, delays in information retrieval, issues with storing data, and inaccurate information retrieval. The enterprise resource planning (ERP) college online application unifies all of the modules and features of a college system into a single platform.

### SUMMARY

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

The present invention is generally directed to an ERP system platform for academic institutions. The system employs innovative way to run any business. The system provides strategy which will make the integration process easier. The system is tested in practice in conjunction with the business that is ready to engage in such an implementation process. The system is a better administration of procedures and control over university operations. Also, it will serve as a novel set of specifications for ERP in higher education, to which ERP providers will reply with a brand-new ERP that focuses on the actual requirements of higher education.

Some of the objects of the present disclosure, which at least one embodiment herein satisfies, are as follows.

It is an object of the present disclosure to ameliorate one or more problems of the prior art or to at least provide a useful alternative

An object of the present disclosure is to provide a system that is user-friendly and has strong data system, which decreases the amount of manual labor required to manage the college system.

Another object of the present disclosure is to provide system that is beneficial in a variety of ways, including updating records, lowering or eliminating the need for human labor, storing vast volumes of data, producing precise computations, and managing files effectively and adaptably.

Another object of the present disclosure is to provide a system that ensure better performance.

Another object of the present disclosure is to provide a system that helps to monitor the educational development of institution.

Yet another object of the present disclosure is to provide a system that saves a lot of time that can be used to develop better strategies to engage and benefit employees.

Yet another object of the present disclosure is to provide a system that updates and maintain a system efficiently.

Other objects and advantages of the present disclosure will be more apparent from the following description, which is not intended to limit the scope of the present disclosure.

### BRIEF DESCRIPTION OF THE DRAWINGS

The FIGURE illustrates the block diagram of an ERP system platform for academic institutions, in accordance with an embodiment of the present invention.

### DETAILED DESCRIPTION

The following description is of exemplary embodiments only and is not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention.

The FIGURE illustrates the block diagram of an ERP system platform for academic institutions, in accordance with an embodiment of the present invention. The system (100) comprises of an enterprise resource planning database, an implementation module, an updating unit, and an application server. The enterprise resource planning database is used to process and store the data in real time. The implementation module is used to process, configure and deploy the enterprise resource planning in institutions. The updating unit is used to update the information of all components on enterprise resource planning database. The application server is connected with internet, to handle all the information between enterprise resource planning database and multiple users. The ERP system platform for academic institutions has been explored to deal with the issues related to a particular institution.

The system (100) enables the administrator to add faculty, students, and other events. With the use of our technology, a faculty member may record or input a student's attendance into a database, where it will subsequently be accessible to both students and professors. With a separate student login, the student may view his or her attendance. The admin can submit the schedules for several departments to help students prepare for exams. After that, faculties and students can check the timetable on the online portal. The system (100) offers a simple user interface and a strong data management mechanism, making them highly practical.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

What is claimed is:

1) An ERP system (100) platform for academic institutions, comprising:
i. an enterprise resource planning database is used to process and store the data in real time;
ii. an implementation module is used to process, configure and deploy the enterprise resource planning in institutions;
iii. an updating unit is used to update the information of all components on enterprise resource planning database; and
iv. an application server is connected with internet, to handle all the information between enterprise resource planning database and multiple users.

2) The system (100) of claim 1, wherein the updating unit information can access by the students and faculties of institutions. The information comprises of courses, attendance, notification, timetable or marks.

3) The system (100) of claim 1, wherein the enterprise resource planning database gives users the right information depending on their profiles and system roles.

4) The system (100) of claim 1, wherein the implementation module comprises of organization, institution, college that has number of departments and educational modules such as courses, seminar hall, etc.

5) The system (100) of claim 1, wherein the multiple users include faculty, students, parents, departments or library.

6) The system (100) of claim 1, wherein the ERP system platform for academic institutions has been explored to deal with the issues related to a particular institution.
